(19) United States
(12) Patent Application Publication
(10) Pub. No.: US 2022/0107754 A1
(43) Pub. Date: Apr. 7, 2022

(54) APPARATUS AND METHOD FOR DATA PACKING AND ORDERING

(71) Applicant: ALIBABA GROUP HOLDING LIMITED, George Town (KY)

(72) Inventor: Shu Li, San Mateo, CA (US)

(21) Appl. No.: 17/065,053

(22) Filed: Oct. 7, 2020

(51) Int. Cl. G06F 3/06

(52) U.S. Cl. CPC G06F 3/0659; G06F 3/0656; G06F 3/0679; G06F 3/064; G06F 3/061

(57) ABSTRACT

The present disclosure relates to an apparatus and method for data storage. In some embodiments, an exemplary method includes: aligning a plurality of sets of data blocks in a plurality of queues; buffering the plurality of sets of data blocks from the plurality of queues in one or more data buffers, each set of data blocks in the one or more data buffers having the same order as that in the plurality of queues; and storing the data blocks in each data buffer into a NAND unit.

### BACKGROUND

All modern-day computers have some form of secondary storage for long-term storage of data. Traditionally, hard disk drives (HDDs) were used for this purpose, but computer systems are increasingly turning to solid-state drives (SSDs) as their secondary storage unit. SSDs have many superior characteristics compared to HDDs, most prominently having vastly lower latency and vastly greater transfer speed. Data throughput of SSDs limits an overall processing speed of a processor. To increase data throughput of SSDs, SSD controller receives tens of incoming data blocks and arrange them based on the order in which the incoming data blocks arrive. But this results in unpredictable and unmanageable data placement in SSDs which can reduce the data throughput.

### SUMMARY

In some embodiments, an exemplary method for data storage can include: aligning a plurality of sets of data blocks in a plurality of queues; buffering the plurality of sets of data blocks from the plurality of queues in one or more data buffers, each set of data blocks in the one or more data buffers having the same order as that in the plurality of queues; and storing the data blocks in each data buffer into a NAND unit.

In some embodiments, an exemplary apparatus for data storage includes at least one memory for storing instructions and at least one processor. At least one processor can be configured to execute the instructions to cause the apparatus to perform: aligning a plurality of sets of data blocks in a plurality of queues; buffering the plurality of sets of data blocks from the plurality of queues in one or more data buffers, each set of data blocks in the one or more data buffers having the same order as that in the plurality of queues; and storing the data blocks in each data buffer into a NAND unit.

In some embodiments, an exemplary non-transitory computer readable storage medium storing a set of instructions that are executable by one or more processing devices to cause a computer to perform: aligning a plurality of sets of data blocks in a plurality of queues; buffering the plurality of sets of data blocks from the plurality of queues in one or more data buffers, each set of data blocks in the one or more data buffers having the same order as that in the plurality of queues; and storing the data blocks in each data buffer into a NAND unit.

Additional features and advantages of the present disclosure will be set forth in part in the following detailed description, and in part will be obvious from the description, or may be learned by practice of the present disclosure. The features and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 illustrates a schematic representation of an exemplary simplified internal structure of an SSD, according to some embodiments of the present disclosure.

FIG. 2 illustrates a schematic representation of the basic layout of an exemplary internal structure of a NAND subcomponent of an SSD, according to some embodiments of the present disclosure.

FIG. 3 illustrates a schematic representation of an exemplary write process to an SSD.

FIG. 4 illustrates a schematic representation of an exemplary write process to an SSD with channel and queue pair assignment, according to some embodiments of the present disclosure.

FIG. 5 illustrates a schematic representation of an exemplary write process of a data chunk to an SSD, according to some embodiments of the present disclosure.

FIG. 6 illustrates a schematic representation of an exemplary write process of multiple data chunks to an SSD, according to some embodiments of the present disclosure.

FIG. 7 illustrates a schematic representation of an exemplary write process of multiple namespaces to an SSD, according to some embodiments of the present disclosure.

FIG. 8 illustrates a flowchart of an exemplary method for data storage, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses, systems and methods consistent with aspects related to the invention as recited in the appended claims.

Modern day computers are based on the Von Neuman architecture. As such, broadly speaking, the main components of a modern-day computer can be conceptualized as two components: something to process data, called a processing unit, and something to store data, called a primary storage unit. The processing unit (e.g., CPU) fetches instructions to be executed and data to be used from the primary storage unit (e.g., RAM), performs the requested calculations, and writes the data back to the primary storage unit. Thus, data is both fetched from and written to the primary storage unit, in some cases after every instruction cycle. This means that the speed at which the processing unit can read from and write to the primary storage unit can be important to system performance. Should the speed be insufficient, moving data back and forth becomes a bottleneck on system performance. This bottleneck is called the Von Neumann bottleneck.

Thus, high speed and low latency are factors in choosing an appropriate technology to use in the primary storage unit. Modern day systems typically use DRAM. DRAM can transfer data at dozens of GB/s with latency of only a few nanoseconds. However, in maximizing speed and response time, there can be a tradeoff. DRAM has three drawbacks. DRAM has relatively low density in terms of amount of data stored, in both absolute and relative measures. DRAM has a much lower ratio of data per unit size than other storage technologies and would take up an unwieldy amount of space to meet current data storage needs. DRAM is also significantly more expensive than other storage media on a price per gigabyte basis. Finally, and most importantly, DRAM is volatile, which means it does not retain data if power is lost. Together, these three factors make DRAM not as suitable for long-term storage of data. These same limitations are shared by most other technologies that possess the speeds and latency needed for a primary storage device.

Thus, in addition to having a processing unit and a primary storage unit, modern-day computers also have a secondary storage unit. What differentiates primary and secondary storage is that the processing unit has direct access to data in the primary storage unit, but not the secondary storage unit. Rather, to access data in the secondary storage unit, the data from the second storage unit is first transferred to the primary storage unit. This forms a hierarchy of storage, where data is moved from the secondary storage unit (non-volatile, large capacity, high latency, low bandwidth) to the primary storage unit (volatile, small capacity, low latency, high bandwidth) to make the data available to process. The data is then transferred from the primary storage unit to the processor, perhaps several times, before the data is finally transferred back to the secondary storage unit. Thus, like the link between the processing unit and the primary storage unit, the speed and response time of the link between the primary storage unit and the secondary storage unit assists with system performance. Should its speed and responsiveness prove insufficient, moving data back and forth between the memory unit and secondary storage unit can also become a bottleneck on system performance.

Traditionally, the secondary storage unit in a computer system was HDD. HDDs are electromechanical devices, which store data by manipulating the magnetic field of small portions of a rapidly rotating disk composed of ferromagnetic material. But HDDs have several limitations that make them less favored in modern day systems. In particular, the transfer speeds of HDDs are largely stagnated. The transfer speed of an HDD is largely determined by the speed of the rotating disk, which begins to face physical limitations above a certain number of rotations per second (e.g., the rotating disk experiences mechanical failure and fragments). Having largely reached the current limits of angular velocity sustainable by the rotating disk, HDD speeds have mostly plateaued. However, CPU's did not face a similar limitation. As the amount of data accessed continued to increase, HDD speeds increasingly became a bottleneck on system performance. This led to the search for and eventually introduction of a new memory storage technology.

The storage technology ultimate chosen was flash memory. Flash storage is composed of circuitry, principally logic gates composed of transistors. Since flash storage stores data via circuitry, flash storage is a solid-state storage technology, a category for storage technology that doesn't have (mechanically) moving components. A solid-state based device has advantages over electromechanical devices such as HDDs, because solid-state devices does not face the physical limitations or increased chances of failure typically imposed by using mechanical movements. Flash storage is faster, more reliable, and more resistant to physical shock. As its cost-per-gigabyte has fallen, flash storage has become increasingly prevalent, being the underlying technology of flash drives, SD cards, the non-volatile storage unit of smartphones and tablets, among others. And in the last decade, flash storage has become increasingly prominent in PCs and servers in the form of SSDs.

SSDs are, in common usage, secondary storage units based on flash technology. Technically referring to any secondary storage unit that doesn't involve mechanically moving components, SSDs are almost exclusively made using flash technology. As such, SSDs do not face the mechanical limitations encountered by HDDs. SSDs have many of the same advantages over HDDs as flash storage such as having significantly higher speeds and much lower latencies.

As a basic overview, SSDs are made using floating gate transistors, strung together in strings. Strings are then laid next to each other to form two dimensional matrixes of floating gate transistors, referred to as blocks. Running transverse across the strings of a block (so including a part of every string), is a page. Multiple blocks are then joined together to form a plane, and multiple planes are formed together to form a NAND die of the SSD, which is the part of the SSD that permanently stores data. Blocks and pages are typically conceptualized as the building blocks of an SSD, because pages are the smallest unit of data which can be written to an read from, while blocks are the smallest unit of data that can be erased.

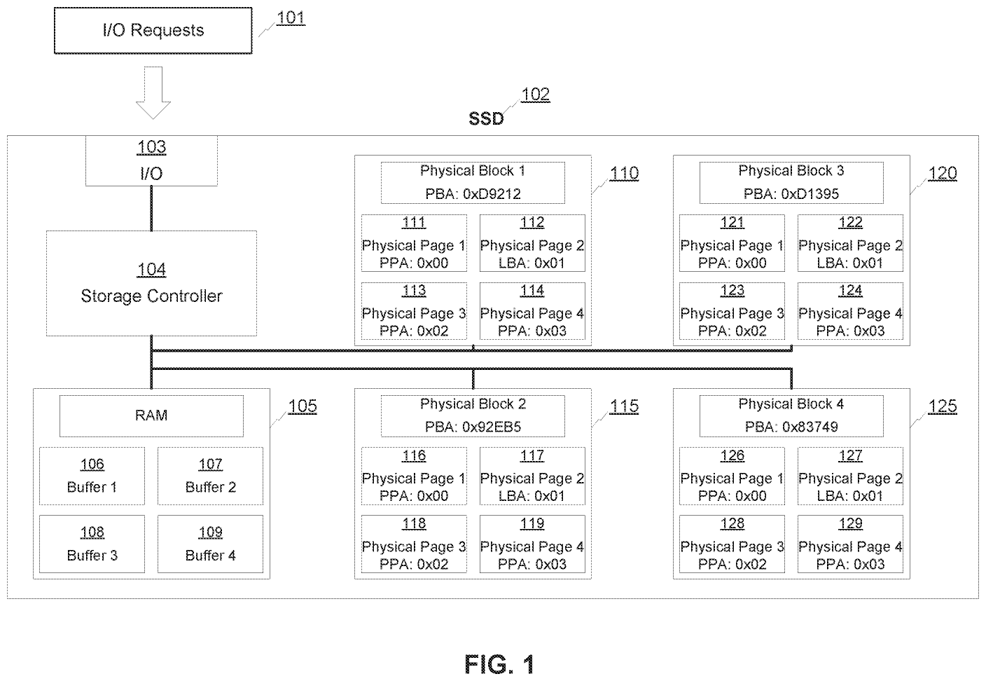

FIG. 1 illustrates a schematic representation of an exemplary simplified internal structure of an SSD 102, according to some embodiments of the present disclosure. Specifically, FIG. 1 shows how an SSD 102 is composed of an I/O interface 103 through which the SSD communicates to the host system. Connected to the I/O interface 103 is the storage controller 104, which contains processors that control the functionality of the SSD. Storage controller 104 is connected to RAM 105, which contains multiple buffers, shown here as buffers 106, 107, 108, and 109. Storage controller 104 is then shown as being connected to physical blocks 110, 115, 120, and 125. As shown by physical block 110, each physical block has a physical block address (PBA), which uniquely identifies the physical block. Also shown by physical block 110 is that each physical block is made up of physical pages, which, for physical block 110, are physical pages 111, 112, 113, and 114. Each page also has its own physical page address (PPA), which is unique within its block. Together, the physical block address along with the physical page address uniquely identifies a page—analogous to combining a 7-digit phone number with its area code. Omitted from FIG. 1 are planes of blocks. In an actual SSD, a storage controller is connected not to physical blocks, but to planes, each of which is composed of physical blocks.

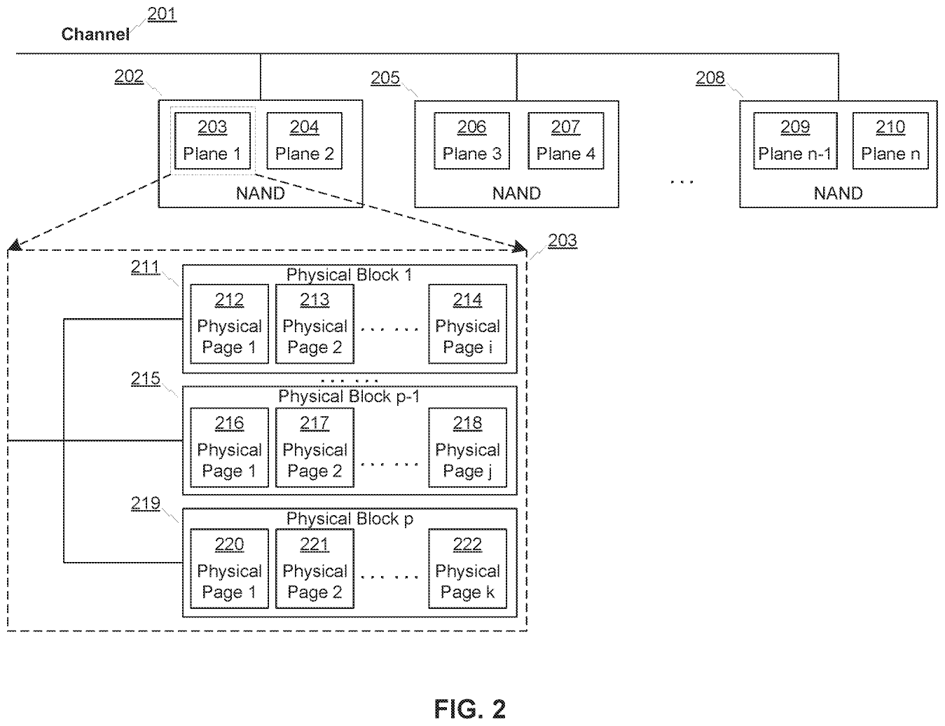

FIG. 2 illustrates a schematic representation of the basic layout of an exemplary internal structure of a NAND subcomponent of an SSD, according to some embodiments of the present disclosure. As stated above, a storage controller (e.g., storage controller 104 of FIG. 1) of an SSD is connected with one or more NAND flash integrated circuits (ICs), which is where any data received by the SSD is ultimately stored. Each NAND IC 202, 205, and 208 typically contains one or more planes. Using NAND IC 202 as an example, NAND IC 202 includes planes 203 and 204. As stated above, each plane is then composed of multiple physical blocks. For example, plane 203 is composed of physical blocks 211, 215, and 219. Each physical block is then further composed of physical pages, which, for physical block 211, are physical pages 212, 213, and 214.

Non-Volatile Memory express (NVMe) protocol supports up to 64K queues in parallel. During deployment of SSDs, multiple queues has been used to increase parallelism at host interface for improving data throughput. The SSD receives data blocks from multiple submission queues and set door knobs of completion queues. Application of multiple queues requires collaborative work from parties in a I/O stack.

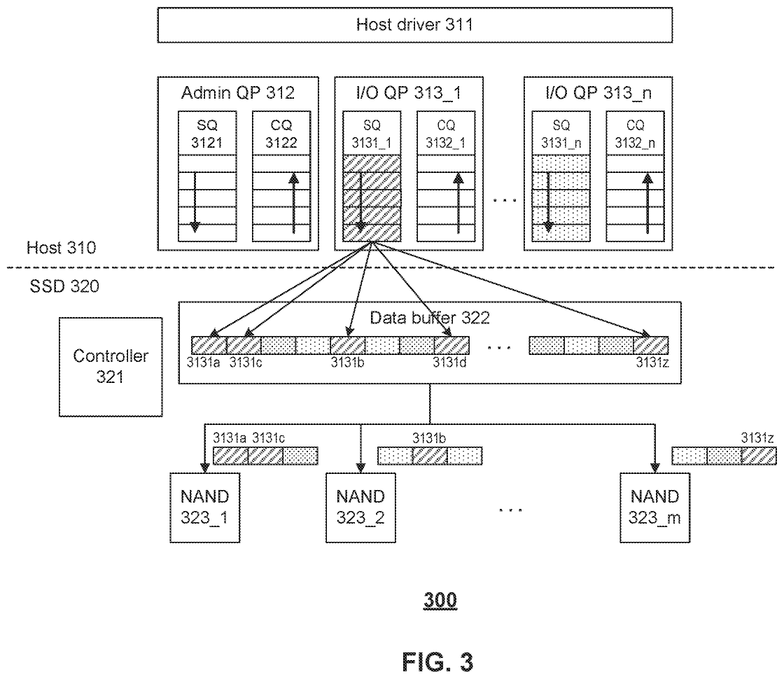

FIG. 3 illustrates a schematic representation of an exemplary write process 300 to an SSD. As shown in FIG. 3, a host unit 310 (e.g., a central processing unit (CPU)) can include a host driver 311 and a plurality of queue pairs (QPs). A queue pair can include a pair of submission queue (SQ) and completion queue (CQ). In some embodiments, the submission queue is a circular buffer with a fixed slot size that host unit 310 uses to submit commands for execution or data blocks for storage by SSD 320. The completion queue is a circular buffer with a fixed slot size used to post status for completed commands or events. The plurality of queue pairs can include an administration queue pair 312 (e.g., Admin QP 312) and multiple I/O queue pairs 313 (e.g., I/O QP 313_1, . . . , I/O QP 313_n). Admin QP 312 can include a submission queue 3121 and a completion queue 3122. I/O QP 313 (e.g., I/O QP 313_1 or I/O QP 313_n) can include one or more submission queues 3131 (e.g., SQ 3131_1 or SQ 3131_n) and a completion queue 3132 (e.g., CQ 3132_1 or CQ 3132_n).

Host driver 311 can align commands or data blocks in the queue pairs. For example, host driver 311 can align one or more commands in SQ 3121 of Admin QP 312, such as create I/O SQ, delete I/O SQ, create I/O CQ, delete I/O CQ, get log page, identify, abort, set features, get features, asynchronous event request, or the like. Moreover, host driver 311 can align one or more commands in SQ 3131_1 of I/O QP 313_1 or SQ 3131_n of I/O QP 313_n, such as read, write, or flush. Host driver 311 can also align one or more data blocks in SQ 3131_1 of I/O QP 313_1 or SQ 3131_n of I/O QP 313_n for storage in SSD 320.

As shown in FIG. 3, SSD 320 can include a controller 321 (e.g., storage controller 104 of FIG. 1), a data buffer 322 (e.g., buffer 106, buffer 107, buffer 108, or buffer 109 in RAM 105 of FIG. 1), one or more NAND units 323 (e.g., physical block 110, physical block 115, physical block 120, or physical block 125 of FIG. 1, NAND IC 202, NAND IC 205, or NAND IC 208 of FIG. 1), or the like. For example, one or more NAND units 323 can include NAND unit 323_1, NAND unit 323_2, . . . , and NAND unit 323_m.

Controller 321 can execute commands in SQ 3121 of Admin QP 312, SQ 3131_1 of I/O QP 313_1, or SQ 3131_n of I/O QP 313_n. For example, controller 321 can execute a write command in SQ 3131_1 of I/O QP 313_1 and receive a plurality of data blocks (e.g., data blocks 3131a, 3131b, 3131c, 3131d, . . . , and 3131z) aligned in SQ 3131_1 of I/O QP 313_1. Controller 321 can temporarily store data blocks 3131a, 3131b, 3131c, 3131d, . . . , and 3131z in data buffer 322, as shown in FIG. 3. Similarly, controller 321 can also receive data blocks from other I/O SQ (e.g., I/O SQ 3131_n) and store received data blocks in data buffer 322. The received data blocks can be arranged in data buffer 322 based on an order in which they arrive. Thus, although data blocks 3131a, 3131b, 3131c, 3131d, . . . , and 3131z are sequentially aligned in and transmitted from SQ 3131_1, they may not arrive sequentially at data buffer 322. For example, as shown in FIG. 3, data block 3131c arrives at data buffer earlier than data block 3131b and thus is stored adjacent to data block 3131a and before data block 3131b. In addition, there may be other data blocks from other SQs (e.g., I/O SQ 3131_n) that arrive at data buffer 322 during transmission of data blocks 3131a, 3131b, 3131c, 3131d, . . . , and 3131z. Then, as shown in FIG. 3, data blocks 3131a, 3131b, 3131c, 3131d, . . . , and 3131z are mixed with other data blocks in data buffer 322.

Controller 321 can sequentially store data blocks in data buffer 322 into NAND unit 323_1, NAND unit 323_2, . . . , and NAND unit 323_m. As shown in FIG. 3, data block 3131a and 3131c are stored in NAND unit 323_1 with another data block from another SQ. Data block 3131b is stored in NAND unit 323_2 with two data blocks from SQ 3131_n. Data block 3131z is stored in NAND unit 323_m with two data blocks, including one data block from SQ 3131_n.

Because there is no prediction or guarantee on arrival sequence of the input data blocks from SQs of host unit 310, the order of received data blocks in data buffer 322 can not be predicted or controlled even though the data blocks are aligned in a desired order in SQs of host unit 310. Controller 321 of SSD 320 assigns physical addresses for data blocks sequentially (e.g., based on their arrival sequence). Actual data placement in NAND units 323 is unpredictable and unmanageable. Since the multiple SQs make the data blocks out of order, one way to maintain the original sequence aligned in the SQs is to activate one queue at one time only. But this can limit the performance of SSD 320.

Moreover, the data blocks mixed together in SSD 320 have unexpected access frequencies. The mixed placement leads to enlarged write amplification due to the data expiration and recycle. The mixed placement breaks the physical continuousness, and makes the sequential read into random read, which results in the read amplification and latency increase.

Some embodiments of the present disclosure can improve the performance of the SSD. For example, some embodiments can reduce write or read amplification and latency.

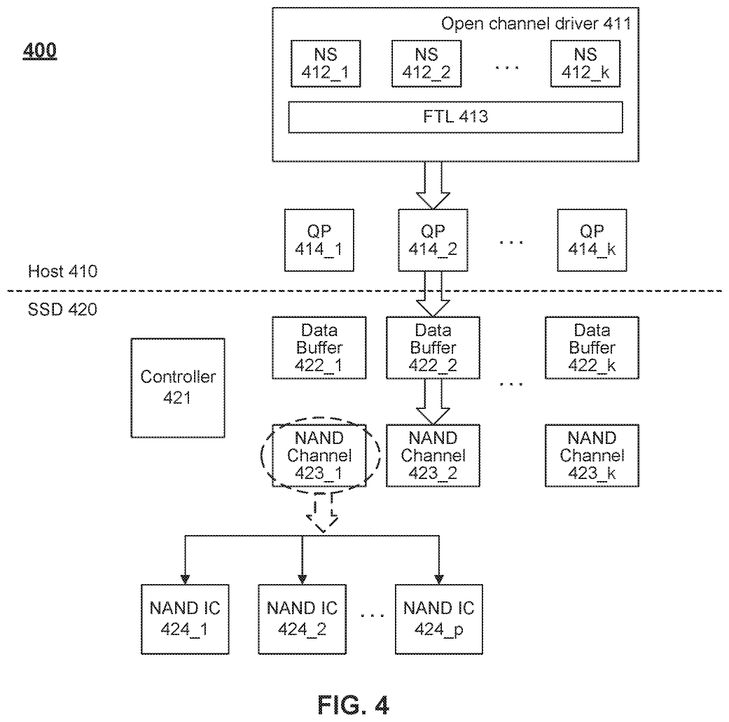

FIG. 4 illustrates a schematic representation of an exemplary write process 400 to an SSD with channel and queue pair assignment, according to some embodiments of the present disclosure. It is appreciated that, write process 400 can be implemented, at least in part, by SSD 102 of FIG. 1, NAND IC 202, 205, or 208 of FIG. 2, or SSD 320 of FIG. 3.

As shown in FIG. 4, host unit 410 can include an open channel driver 411. Open channel driver 411 can include one or more namespaces (NSs) 412 (e.g., namespaces NS 412_1, NS 412_2, . . . , and NS 412_k), a flash translation layer (FTL) 413, and the like. Each namespace 412 can include a plurality of logic block addresses (LBAs). For example, namespace NS 412_1, NS 412_2, . . . , or NS 412_k can include 32 LBAs. Open channel driver 411 can assign a namespace to a plurality of data blocks. For example, namespace NS 412_1 can be assigned to a first set of data blocks (e.g., 32 data blocks). Similarly, namespace NS 412_i can be assigned to an i-th set of data blocks, where i is between 1 and k, inclusive.

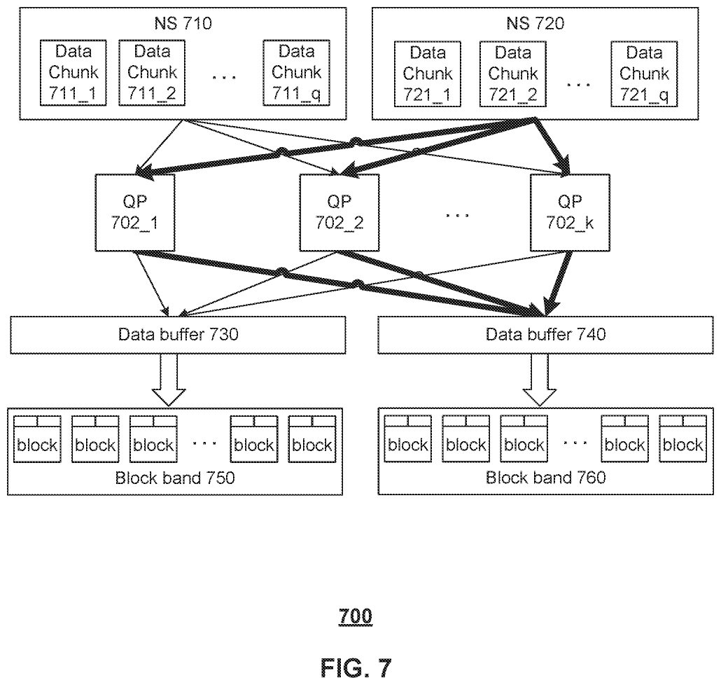

FTL 413 can translate the LBAs in a namespace 412 to physical block addresses (PBAs) or physical page addresses (PPAs) in SSD 420. Thus, the PBAs or PPAs are also signed to the set of data blocks corresponding to the LBAs in the namespace 412. For example, the PBAs corresponding to the LBAs in namespace NS 412_i are assigned to the i-th set of data blocks, where i is between 1 and k, inclusive. With FTL 413, host unit 410 can control the mapping between the LBAs in namespace 412 (e.g., namespaces NS 412_1, NS 412_2, . . . , and NS 412_k) and the PBAs or PPAs in SSD 420. In some embodiments, FTL 413 can translate the LBAs in a namespace 412 to PBAs or PPAs of a NAND unit in SSD 420. The NAND unit can include, but is not limited to, NAND physical page (e.g., physical page 111, 112, 113, 114, 116, 117, 118, 119, 121, 122, 123, 124, 126, 127, 128 or 129 of FIG. 1, physical page 212, 213, 214, 216, 217, 218, 220, 221, or 222 of FIG. 2), NAND physical block (e.g., physical block 110, 115, 120, 125 of FIG. 1, physical block 211, 215, or 219 of FIG. 2), NAND plane (e.g., plane 203, 204, 206, 207, 209, or 210 of FIG. 2), NAND IC (e.g., NAND IC 202, NAND IC 205, or NAND IC 208 of FIG. 1), NAND channel (e.g., channel 201 of FIG. 2), or NAND block band (e.g., NAND block band 750 or 760 of FIG. 7). As shown in FIG. 4, for example, the NAND unit corresponding to a namespace 412 can be a NAND channel that includes a plurality (e.g., four) of NAND ICs. For example, FTL can translate the LBAs in namespace NS 412_1 to PBAs or PPAs of NAND channel 423_1 in SSD 420 that include NAND IC 424_1, 424_2, . . . , and 424_p. Similarly, FTL can translate the LBAs in namespace NS 412_k to PBAs or PPAs of NAND channel 423_k in SSD 420 that is corresponding to namespace NS 412_k.

Host unit 410 can align a set of data blocks corresponding to the LBAs in a namespace 412 to an SQ of a queue pair in a predetermined order (e.g., in sequential order). For example, host unit 410 can align a first set of data blocks corresponding to the LBAs in namespace NS 412_1 to an SQ of QP 414_1 in a predetermined order (e.g., in sequential order). Generally, host unit 410 can align an i-th set of data blocks corresponding to the LBAs in namespace NS 412_i to an SQ of QP 414_i in a predetermined order. Host unit 410 can output the set of data blocks in QP 414_1, QP 414_2, . . . , or QP 414_k to SSD 420 for storage. In some embodiments, each SQ of QP 414 can have the same length as that of a single NAND unit in SSD 420.

SSD 420 can include a controller 421, one or more data buffers 422 (e.g., data buffer 422_1, data buffer 422_2, . . . , and data buffer 422_k), one or more NAND channels 423 (e.g., NAND channel 423_1, NAND channel 423_2, . . . , and NAND channel 423_k), or the like. Controller 421 can receive the first, second, . . . , or k-th set of data blocks from an SQ of QP 414_1, QP 414_2, . . . , or QP 414_k of host unit 410, respectively, and temporarily store the set of data blocks in a corresponding data buffer, e.g., data buffer 422_1, data buffer 422_2, . . . , or data buffer 422_k, respectively. The data blocks in a data buffer 422 can be kept in the same order as that in QP 414. For example, controller 421 can sequentially receive the first set of data blocks from an SQ of QP 414_1 of host unit 410 and store them in data buffer 422_1. For another example, controller 421 can align received first set of data blocks in the data buffer 422_1 in the same order as that in QP 414_1.

It is appreciated that although data buffer 422_1, data buffer 422_2, . . . , and data buffer 422_k are shown as separate data buffers in FIG. 4, they can be data buffer ranges of one or more data buffers (e.g., data buffer 106, 107, 108, or 109 of RAM 105 of FIG. 1, data buffer 322 of FIG. 3, or the like). In some embodiments, each data buffer 422 can have the same length as that of a single NAND unit in SSD 420. In some embodiments, controller 421 can dynamically control the mapping of data buffers 422 to QPs 414 of host unit 410. For example, during one round of operations (e.g., read, write, or the like), controller 421 can assign a data buffer 422_1 to QP 414_1 of host unit 410. In another round of operations, controller 421 can reassign the data buffer 422_1 to another QP 414 (e.g., QP 414_2, QP 414_k, or the like) of host unit 410.

Controller 421 can store the set of data blocks in data buffer 422 to a NAND channel 423 based on the PBAs or PPAs of the set of data blocks. For example, controller 421 can sequentially store the first set of data blocks in data buffer 422_1 to NAND channel 423_1 that includes the PBAs or PPAs of the first set of data blocks. NAND channel 423_1 can include a plurality of NAND ICs, such as NAND IC 424_1, NAND IC 424_2, . . . , and NAND IC 424_p. In some embodiments, a NAND channel 423 can include four NAND ICs 424 and each NAND IC 424 can have two planes. When one NAND plane is 16 KB, one write command into the NAND channel 423 can accumulate 128 KB.

In some embodiments, a set of data blocks can be stored into SSD 420 in parallel with other sets of data blocks. For example, the first set of data blocks corresponding to namespace NS 412_1 can go through QP 414_1, data buffer 422_1, and enter NAND channel 423_1, while the second set of data blocks corresponding to namespace NS 412_2 can go through QP 414_2, data buffer 422_2, and enter NAND channel 423_2.

Some embodiments of the present disclosure can utilize multiple queues (e.g., QP 414_1, QP 414_2, . . . , and QP 414_k) for an open channel SSD with flexible data placement, thus achieving performance gain. In some embodiments, with a write command, for example, a set of data blocks to be written can pass through a queue and a data buffer with the same order and can enter into an assigned NAND channel. Some embodiments of the present disclosure can have one queue to transfer a set of data blocks for one NAND channel at each time. When the data buffer (e.g., data buffer 422_1, data buffer 422_2, . . . , or data buffer 422_k) of the SSD receives data blocks all from the same queue, controller 421 can write the received data into one NAND channel (e.g., NAND channel 423_1, NAND channel 423_2, . . . , or NAND channel 423_k) together.

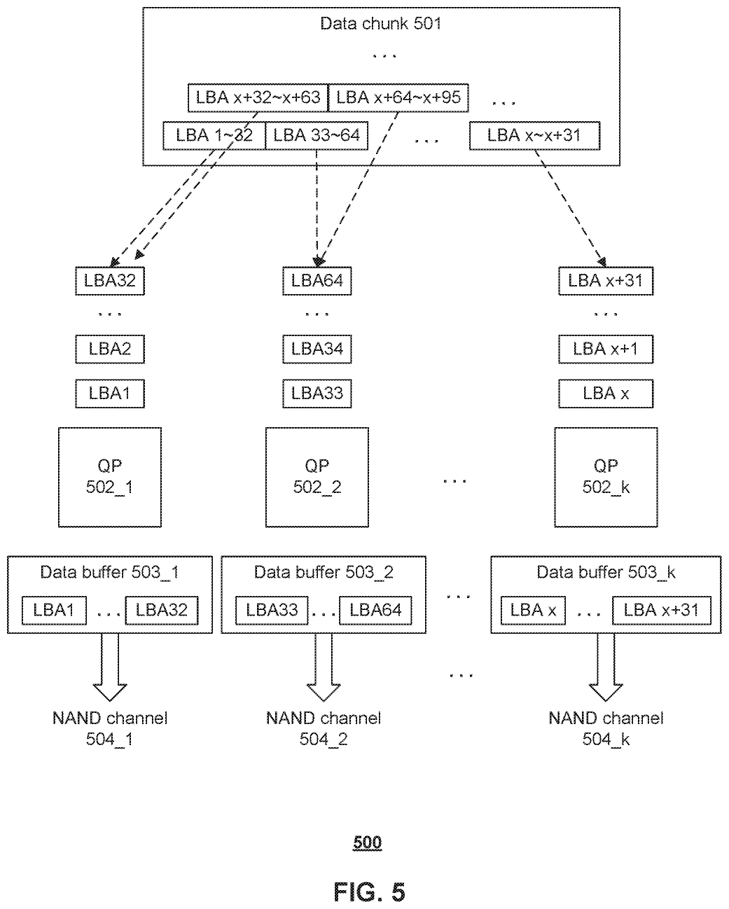

FIG. 5 illustrates a schematic representation of an exemplary write process 500 of a data chunk to an SSD, according to some embodiments of the present disclosure. It is appreciated that, write process 500 can be implemented, at least in part, by SSD 102 of FIG. 1, NAND IC 202, 205, or 208 of FIG. 2, SSD 320 of FIG. 3, or host unit 410 and SSD 420 of FIG. 4.

As shown in FIG. 5, a data chunk 501 can include one or more sets of data blocks. Each set of data blocks can be assigned (e.g., by open channel driver 411 of host unit 410 of FIG. 4) with a set of LBAs. For example, as shown in FIG. 5, LBAs 1-32 can be assigned to a first set of 32 data blocks, LBAs 33-64 can be assigned to a second set of 32 data blocks, and so on. It is appreciated that, the blocks labeled with LBA numerals in FIG. 5 represent respective data blocks corresponding to the LBA numerals.

A set of data blocks can be aligned in an SQ of a QP 502 in a predetermined order (e.g., in a sequential order). For example, a host unit (e.g., host unit 410 of FIG. 4) can sequentially align the first set of data block, LBA 1, LBA 2, . . . , and LBA 32, in an SQ of QP 502_1. Similarly, the host unit can sequentially align LBA x, LBA x+1, . . . , and LBA x+31, in an SQ of QP 502_k.

The set of data blocks aligned in an SQ of a QP 502 can be input into a corresponding data buffer 503 and then stored into a corresponding NAND unit. The set of data blocks in data buffer 503 can be kept in the same order as that in QP 502 and sequentially stored into corresponding NAND unit. For example, a controller of an SSD (e.g., controller 104 of SSD 102 of FIG. 1, controller 321 of SSD 320 of FIG. 3, or controller 421 of SSD 420 of FIG. 4) can sequentially receive the first set of data block, LBA 1, LBA 2, . . . , and LBA 32, from the SQ of QP 502_1 and temporarily store the received first set of data blocks in data buffer 503_1 in the same order as that in the SQ of QP 502_1. Then, the controller can store the first set of data blocks sequentially into a corresponding NAND channel 504_1.

It is appreciated that although data buffer 503_1, data buffer 503_2, . . . , and data buffer 503_k are shown as separate data buffers in FIG. 5, they can be data buffer ranges of one or more data buffers (e.g., data buffer 106, 107, 108, or 109 of RAM 105 of FIG. 1, data buffer 322 of FIG. 3, or the like). In some embodiments, each SQ of QP 502 and each data buffer 503 can have the same length as that of a single NAND unit (e.g., NAND channel 504) for storage. In some embodiments, the mapping of data buffers 503 to QPs 502 can be dynamically controlled by the controller of SSD or the host unit. For example, during one round of operations (e.g., read, write, or the like), the controller can assign data buffer 503_1 to QP 502_1. In another round of operations, the controller can reassign the data buffer 503_1 to another QP 502_i (e.g., QP 502_2, QP 502_k, or the like).

In some embodiments, the mapping of NAND units 504 to data buffers 503 can also be dynamically controlled by the host unit or the controller of SSD. For example, during execution of a write command, the controller can write a set of data blocks in data buffer 503_1 to NAND channel 504_1. During execution of another write command, the controller can write another set of data blocks in data buffer 503_1 to NAND channel 504_i (e.g., NAND channel 504_2, NAND channel 504_k, or the like).

In some embodiments, a set of data blocks can be stored into the SSD in parallel with other sets of data blocks. For example, the first set of data blocks, LBA 1, LBA 2, . . . , and LBA 32, can go through QP 502_1, data buffer 503_1, and enter NAND channel 504_1, while the second set of data blocks, LBA 33, LBA 34, . . . , and LBA 64, can go through QP 502_2, data buffer 503_2, and enter NAND channel 504_2.

In some embodiments, LBAs of a set of data blocks in data chunk 501 can be translated (e.g., by FTL 413 of host unit 410 of FIG. 4) to PBAs or PPAs corresponding to a specific NAND unit. The host unit can determine or control the physical addresses in SSD for the set of data blocks in data chunk 501. For example, the first set of data blocks, LBA 1, LBA 2, . . . , and LBA 32, can be stored from data buffer 503_1 into NAND channel 504_1 that include physical blocks with physical block addresses, PBA 1, PBA 2, . . . , and PBA 32. Physical block addresses, PBA 1, PBA 2, . . . , and PBA 32, are corresponding to logical block addresses, LBA 1, LBA 2, . . . , and LBA 32.

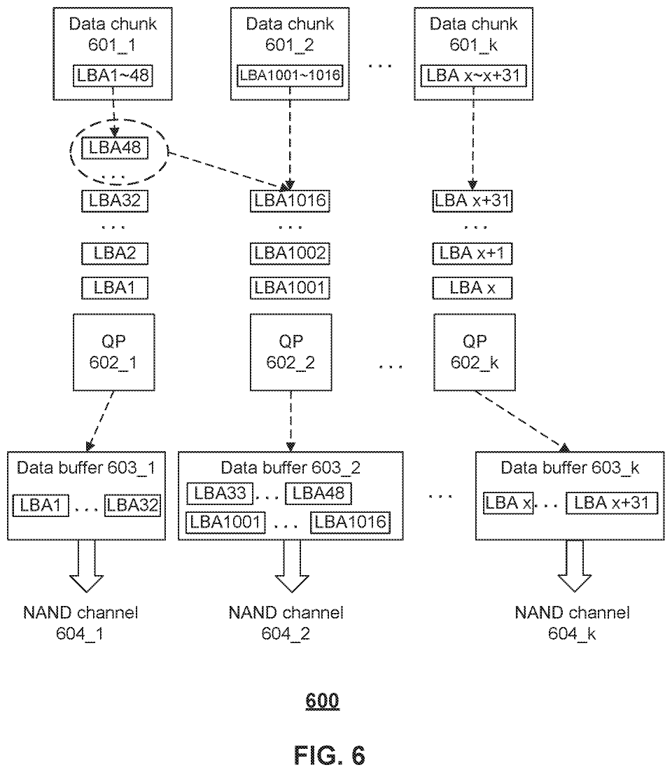

FIG. 6 illustrates a schematic representation of an exemplary write process 600 of multiple data chunks to an SSD, according to some embodiments of the present disclosure. It is appreciated that write process 600 can be implemented, at least in part, by SSD 102 of FIG. 1, NAND IC 202, 205, or 208 of FIG. 2, SSD 320 of FIG. 3, or host unit 410 and SSD 420 of FIG. 4.

As shown in FIG. 6, there can be a plurality of data chunks 601, such as data chunk 601_1, data chunk 601_2, . . . , and data chunk 601_k. A data chunk 601 can include one or more data blocks. The data blocks in data chunk 601 can be assigned (e.g., by open channel driver 411 of host unit 410 of FIG. 4) with LBAs. For example, as shown in FIG. 6, data chunk 601_1 can include 48 data blocks to which logical block addresses, LBA 1-48, can be assigned, data chunk 601_2 can include 16 data blocks to which logical block addresses, LBA 1001-1016, can be assigned, and so on. It is appreciated that, the blocks labeled with LBA numerals in FIG. 6 represent respective data blocks corresponding to the LBA numerals.

Data blocks from the data chunks 601_1, 601_2, . . . , and 601_k, can be aligned in SQs of QP 602_1, QP 602_2, . . . , and QP 602_k in predetermined orders (e.g., in a sequential order). Data chunks 601_1, 601_2, . . . , and 601_k may have different lengths. Some data chunks may have lengths larger than that of a single NAND unit while some other data chunks may have lengths smaller than that of single NAND unit. As shown in FIG. 6, for example, a single NAND channel (e.g., NAND channel 604_1, NAND channel 604_2, . . . , or NAND channel 604_k) may have a length of 32 data blocks. Data chunk 601_1 can include 48 data blocks, LBA 1-48, that exceed the length of NAND channel 604_1, while data chunk 601_2 can include 16 data blocks, LBA 1001-1016, that are less than the length of NAND channel 604_2. In such case, a part of data chunk 601_1, data blocks LBA 1-32, can be sequentially aligned in QP 602_1. The other part of data chunk 601_1, data blocks LBA 33-48, can be sequentially aligned in QP 602_2 together with data blocks LBA 1001-1016 of data chunk 601_2. Data blocks LBA 33-48 of data chunk 601_1 are not mixed with sequentially aligned data blocks LBA 1001-1016 of data chunk 601_2. Data chunk 601_k has a length equal to or less than that of single NAND channel. Data blocks LBA x-(x+31) of data chunk 601_k can be sequentially aligned in QP 602_k.

A set of data blocks aligned in an SQ of a QP 602 can be input into a corresponding data buffer 603 and then stored into a corresponding NAND unit. The set of data blocks in data buffer 603 can be kept in the same order as that in QP 602 and sequentially stored into corresponding NAND unit. For example, a controller of an SSD (e.g., controller 104 of SSD 102 of FIG. 1, controller 321 of SSD 320 of FIG. 3, or controller 421 of SSD 420 of FIG. 4) can receive a first set of data blocks, LBA 1, LBA 2, . . . , and LBA 32 of data chunk 601_1, from the SQ of QP 602_1 and temporarily store the received first set of data blocks in data buffer 603_1 in the same order as that in the SQ of QP 602_1. Then, the controller can store the first set of data blocks sequentially into a corresponding NAND channel 604_1. The controller of the SSD can receive a second set of data blocks, LBA 33, . . . , and LBA 48 of data chunk 601_1 and LBA 1001, . . . , LBA 1016 of data chunk 601_2, from the SQ of QP 602_2 and temporarily store the received second set of data blocks in data buffer 603_2 in the same order as that in the SQ of QP 602_2. Then, the controller can store the second set of data blocks sequentially into a corresponding NAND channel 604_2.

It is appreciated that, although data buffer 603_1, data buffer 603_2, . . . , and data buffer 603_k are shown as separate data buffers in FIG. 6, they can be data buffer ranges of one or more data buffers (e.g., data buffer 106, 107, 108, or 109 of RAM 105 of FIG. 1, data buffer 322 of FIG. 3, or the like). In some embodiments, each SQ of QP 602 and each data buffer 603 can have the same length as that of a single NAND unit (e.g., NAND channel 604) for storage. In some embodiments, the mapping of data buffers 603 to QPs 602 can be dynamically controlled by the controller of SSD or the host unit. For example, during one round of operations (e.g., read, write, or the like), the controller can assign data buffer 603_1 to QP 602_1. In another round of operations, the controller can reassign the data buffer 603_1 to another QP 602_i (e.g., QP 502_2, QP 502_k, or the like).

In some embodiments, the mapping of NAND units 604 to data buffers 603 can also be dynamically controlled by the host unit or the controller of SSD. For example, during execution of a write command, the controller can write a set of data blocks in data buffer 603_1 to NAND channel 604_1. During execution of another write command, the controller can write another set of data blocks in data buffer 603_1 to NAND channel 604_i (e.g., NAND channel 604_2, NAND channel 604_k, or the like).

In some embodiments, multiple data chunks (e.g., data chunk 601_1, data chunk 601_2, . . . , and data chunk 601_k) can be stored into the SSD in parallel. For example, the first set of data blocks, LBA 1, LBA 2, . . . , and LBA 32 of data chunk 601_1, can go through QP 602_1, data buffer 603_1, and enter NAND channel 604_1, while the second set of data blocks, LBA 33, . . . , and LBA 48 of data chunk 601_1 and LBA 1001, . . . , and LBA 1016 of data chunk 601_2, can go through QP 602_2, data buffer 603_2, and enter NAND channel 604_2.

In some embodiments, LBAs of data blocks in data chunk 601 can be translated (e.g., by FTL 413 of host unit 410 of FIG. 4) to PBAs or PPAs corresponding to one or more NAND units. The host unit can determine or control the physical addresses in SSD for the data blocks in data chunk 601. For example, the first set of data blocks, LBA 1, LBA 2, . . . , and LBA 32 of data chunk 601_1, can be stored from data buffer 603_1 into NAND channel 604_1 that include physical blocks with physical block addresses, PBA 1, PBA 2, . . . , and PBA 32. Physical block addresses, PBA 1, PBA 2, . . . , and PBA 32, are corresponding to logical block addresses, LBA 1, LBA 2, . . . , and LBA 32.

In some embodiments, multiple data chunks can be launched simultaneously. For example, in a distributed file system like Hadoop Distributed File System (HDFS), a data chunk can be allocated a certain amount of logical space. Data blocks can be placed into this data chunk until it is full and sealed. The multiple data chunks may have different lengths. Some embodiments of the present disclosure can improve write performance of the multiple data chunks.

FIG. 7 illustrates a schematic representation of an exemplary write process 700 of multiple namespaces to an SSD, according to some embodiments of the present disclosure. It is appreciated that write process 500 can be implemented, at least in part, by SSD 102 of FIG. 1, NAND IC 202, 205, or 208 of FIG. 2, SSD 320 of FIG. 3, or host unit 410 and SSD 420 of FIG. 4.

As shown in FIG. 7, there can be a plurality of namespaces (NSs), such as namespaces NS 710, NS 720, and the like. Each namespace can include one or more data chunks. For example, namespace NS 710 can include data chunk 711_1, data chunk 711_2, . . . , and data chunk 711_q, while namespace NS 720 can include data chunk 721_1, data chunk 721_2, . . . , and data chunk 721_q. A data chunk 721 can include one or more data blocks that can be assigned (e.g., by open channel driver 411 of host unit 410 of FIG. 4) with LBAs.

Data blocks from the data chunks 711_1, 711_2, . . . , and 711_q, can be aligned in SQs of QP 702_1, QP 702_2, . . . , and QP 702_k in predetermined orders (e.g., in a sequential order). Data chunks 711_1, 711_2, . . . , and 711_q may have different lengths. Some data chunks may have lengths larger than that of a single SQ of QP 702 while some other data chunks may have lengths smaller than that of single SQ of QP 702. For a data chunk 711 having a length equal to or smaller than that of single SQ of QP 702, its data blocks can be sequentially aligned in an SQ of QP 702. For another data chunk 711 having a length larger than that of single SQ of QP 702, its data blocks can be sequentially aligned in two or more SQs that can be in one or more QPs 702. In some embodiments, similar to write process 600 of FIG. 6, data blocks from different data chunks (e.g., data chunk 601_1 and data chunk 601_2) can be aligned in the same SQ or QP (e.g., QP 602_2).

The sets of data blocks aligned in SQs of QPs 702 can be input into a corresponding data buffer 730 and then stored into a corresponding NAND unit (e.g., block band 750). Each set of data blocks in data buffer 730 received from the same SQ of QP 702 can be kept in the same order as that in the SQ and sequentially stored into corresponding NAND unit. For example, a controller of an SSD (e.g., controller 104 of SSD 102 of FIG. 1, controller 321 of SSD 320 of FIG. 3, or controller 421 of SSD 420 of FIG. 4) can receive a first set of data blocks from the SQ of QP 702_1 and temporarily store the received first set of data blocks in data buffer 730 in the same order as that in the SQ of QP 702_1. The controller of the SSD can also receive a second set of data blocks from the SQ of QP 702_2 and temporarily store the received second set of data blocks in data buffer 730 in the same order as that in the SQ of QP 702_2. The first set of data blocks and the second set of data blocks can be sequentially stored in data buffer 730 and not mixed with each other. Other sets of data blocks can also be received from other SQs of QPs 702 and stored in data buffer 730. The controller can store one or more sets of data blocks in data buffer 730 sequentially into a corresponding block band 750 when they are ready, or accumulate all sets of data blocks in data buffer 730 and store them sequentially into a corresponding block band 750 when they are all ready. Block band 705 can include a group of NAND physical blocks. The group of NAND physical blocks can be across multiple NAND channels.

Similar to namespace NS 710, SQs of QP 702_1, QP 702_2, . . . , and QP 702_k can also be used to align data blocks from data chunks 721_1, 721_2, . . . , and 721_q of namespace NS 720 (e.g., after output of the data blocks of namespace NS 710). The sets of data blocks of namespace NS 720 aligned in SQs of QPs 702 can be input into a corresponding data buffer 740 and then stored into a corresponding NAND block band 760. Each set of data blocks in data buffer 740 received from the same SQ of QP 702 can be kept in the same order as that in the SQ. The received sets of data blocks can be sequentially stored into corresponding NAND block band 760. Block band 705 can also include a group of NAND physical blocks that may be across multiple NAND channels.

In some embodiments, data blocks in namespace NS 710 can be stored into the SSD at least partially in parallel with data blocks in namespace NS 720. For example, after the data blocks of namespace NS 710 in QP 702_1 are input into data buffer 730, a set of data blocks of namespace NS 720 can be aligned in QP 702_1 and input in to data buffer 740. Similarly, QP 702_2, . . . , or QP 702_k can also be used to align data blocks of namespace NS 720 after output of data blocks of namespace NS 710.

It is appreciated that, although data buffer 730 and data buffer 740 are shown as separate data buffers in FIG. 7, they can be data buffer ranges of a data buffer (e.g., data buffer 106, 107, 108, or 109 of RAM 105 of FIG. 1, data buffer 322 of FIG. 3, or the like). In some embodiments, data buffer 730 or data buffer 740 can have the same length as that of block band 750 or block band 760, respectively.

In some embodiments, the mapping of block band 750 and 760 to data buffers 730 and 740 can be dynamically controlled by the host unit or the controller of SSD. For example, during execution of a write command, the controller can write data blocks in data buffer 730 to block band 750. During execution of another write command, the controller can write other data blocks in data buffer 730 to block band 760.

In some embodiments, LBAs of data blocks in a namespace (e.g., namespace NS 710 or NS 720) can be translated (e.g., by FTL 413 of host unit 410 of FIG. 4) to PBAs or PPAs corresponding to one or more NAND units. The host unit can determine or control the physical addresses in SSD for the data blocks in a namespace. For example, the data blocks of namespace NS 710 can be stored from data buffer 730 into block band 750 that include physical blocks with physical block addresses corresponding to logical block addresses of the stored data blocks.

Some embodiments of the present disclosure can use multiple namespaces (e.g., namespace NS 710, namespace NS 720, or the like) to realize data placement and physical isolation of data with different hotness, service priority, or the like. The namespaces can collaborate with multiple queues (e.g., QP 702_1, QP 702_2, . . . , and QP 702_k), at least partially in parallel, to place data onto physically isolated NAND spaces (e.g., block band 750, block band 760, or the like). A set of data blocks (e.g., 32 LBAs) of each namespace individually goes through one NVMe queue (e.g. an SQ of QP 702_1, QP 702_2, . . . , or QP 702_k). After output of one set of data blocks, the NVMe queue can be used by another namespace to send it data block set. A data buffer in the SSD can accumulate the data blocks from the same namespace and temporarily hold the data blocks. The data placement in the data buffer can keep the same order as that aligned within every NVMe queue. The data buffer can send one or more sets of data blocks to NAND space when they are ready, or accumulate all sets of data blocks of the same namespace and send them to NAND space when they are all ready.

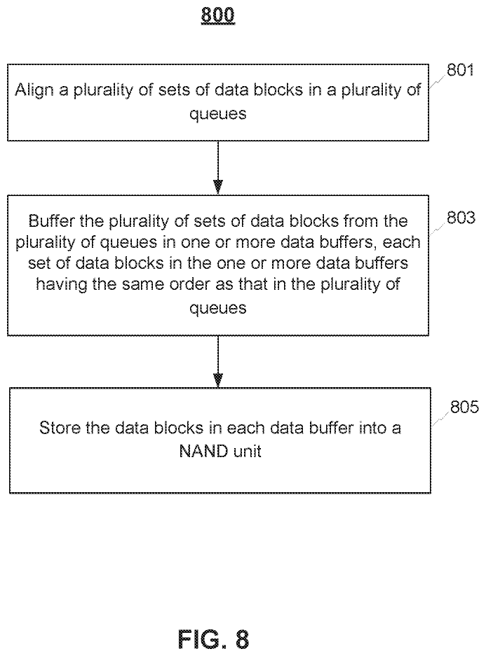

FIG. 8 illustrates a flowchart of an exemplary method 800 for data storage, according to some embodiments of the present disclosure. It is appreciated that, method 800 can be implemented, at least partially, by SSD 102 of FIG. 1, NAND IC 202, NAND IC 205 and NAND IC 208 of FIG. 2, host unit 310 and SSD 320 of FIG. 3, or host unit 410 and SSD 420 of FIG. 4. Method 800 can be applied to write process 400 of FIG. 4, write process 500 of FIG. 5, write process 600 of FIG. 6, or write process 700 of FIG. 7. Moreover, method 800 can also be implemented in software or firmware. For example, method 800 can be implemented by a computer program product, embodied in a computer-readable medium, including computer-executable instructions, such as program code, executed by computers. In some embodiments, a host unit (e.g., host unit 310 of FIG. 3, host unit 410 of FIG. 4, or the like) may compile software code for generating instructions for providing to one or more processors to perform method 800.

As shown in FIG. 8, at step 801, a plurality of sets of data blocks can be aligned in a plurality of queues. For example, a first set of data blocks can be aligned in a first queue, and a second set of data blocks can be aligned in a second queue. In some embodiments, the first set of data blocks are from a first namespace and the second set of data blocks are from a second namespace. For example, as shown in FIG. 4, the first set of data blocks from namespace NS 412_1 can be aligned in QP 414_1, and the second set of data blocks from namespace NS 412_2 can be aligned in QP 414_2. In some embodiments, the first set of data blocks and the second set of data blocks are from a same data chunk. For example, as shown in FIG. 5, the first set of data blocks and the second set of data blocks from data chunk 501 can be aligned in QP 502_1 and QP 502_2, respectively. In some embodiments, the first set of data blocks are from a first data chunk, and a part of the second set of data blocks are from the first data chunk and the other part of the second set of data blocks are from a second data chunk. For example, as shown in FIG. 6, the first set of data blocks, LBAs 1-32, from data chunk 601_1 can be aligned in QP 602_1, and a part of the second set of data blocks, LBAs 33-48, from data chunk 601_1 and the other part of the second set of data blocks, LBAs 1001-1016, from data chunk 601_2 can be aligned in QP 602_2. In some embodiments, the first set of data blocks and the second set of data blocks are from a first namespace. For example, as shown in FIG. 7, first set of data blocks and the second set of data blocks from namespace NS 710 can be aligned in QP 702_1 and QP 702_2, respectively.

At step 803, the plurality of sets of data blocks from the plurality of queues can be buffered in one or more data buffers. Each set of data blocks buffered in the one or more data buffers can have the same order as that it has in the plurality of queues. For each set of data blocks, it can be sequentially received from a queue, and sequentially stored in a data buffer. For example, a first set of data blocks from a first queue (e.g., QP 414_1 of FIG. 4, QP 502_1 of FIG. 5, or QP 602_1 of FIG. 6) can be buffered in a first data buffer (e.g., data buffer 422_1 of FIG. 4, data buffer 503_1 of FIG. 5, or data buffer 603_1 of FIG. 6), and a second set of data blocks from a second queue (e.g., QP 414_2 of FIG. 4, QP 502_2 of FIG. 5, or QP 602_2 of FIG. 6) can be buffered in a second data buffer (e.g., data buffer 422_2 of FIG. 4, data buffer 503_2 of FIG. 5, or data buffer 603_2 of FIG. 6). In some embodiments, a first set of data blocks from a first queue (e.g., QP 702_1 of FIG. 7) and a second set of data blocks from a second queue (e.g., QP 702_2 of FIG. 7) can be buffered in a first data buffer (e.g., data buffer 730 of FIG. 7).

At step 805, the data blocks in each data buffer can be stored into a NAND unit. In some embodiments, the first set of data blocks can be stored into a first NAND unit (e.g., NAND channel 423_1 of FIG. 4, NAND channel 504_1 of FIG. 5, or NAND channel 604_1 of FIG. 6) after buffering the first set of data blocks, and the second set of data blocks can be stored into a second NAND unit (e.g., NAND channel 423_2 of FIG. 4, NAND channel 504_2 of FIG. 5, or NAND channel 604_2 of FIG. 6) after buffering the second set of data blocks. In some embodiments, the first set of data blocks can be stored into a first NAND unit (e.g., NAND block band 750 of FIG. 7) after buffering the first set of data blocks, and the second set of data blocks can be stored into the first NAND unit (e.g., NAND block band 750 of FIG. 7) after buffering the second set of data blocks. In some embodiments, the first set of data blocks and the second set of data blocks can be stored into a first NAND unit (e.g., NAND block band 750 of FIG. 7) after buffering both the first set of data blocks and the second set of data blocks.

In some embodiments, method 800 can include aligning a third set of data blocks in the first queue after buffering the first set of data blocks, aligning a fourth set of data blocks in the second queue after buffering the second set of data blocks, and buffering the third set of data blocks and the fourth set of data blocks in a second data buffer. Method 800 can also include storing the third set of data blocks into a second NAND unit after buffering the third set of data blocks and storing the fourth set of data blocks into the second NAND unit after buffering the fourth set of data blocks. For example, as shown in FIG. 7, a third set of data blocks can be aligned in QP 702_1 after buffering the first set of data blocks and a fourth set of data blocks can be aligned in QP 702_2 after buffering the second set of data blocks. The third set of data blocks and the fourth set of data blocks can be buffered in data buffer 740. The third set of data blocks can be stored into NAND block band 760 after buffering the third set of data blocks and the fourth set of data blocks can be stored into NAND block band 760 after buffering the fourth set of data blocks.

In some embodiments, method 800 can include translating LBAs of the plurality of sets of data blocks to PBAs or PPAs. For example, a controller of an SSD (e.g., controller 104 of SSD 102 of FIG. 1, controller 321 of SSD 320 of FIG. 3, or controller 421 of SSD 420 of FIG. 4) or an FTL of a host unit (e.g., FTL 413 of host unit 410 of FIG. 4) can translate the LBAs of data blocks of a namespace (namespace NS 412_1, NS 412_2, . . . , or NS 412_k of FIG. 4, namespace NS 710 or namespace NS 720 of FIG. 7) or a data chunk (data chunk 501 of FIG. 5, data chunk 601_1, data chunk 601_2, . . . , or data chunk 601_k of FIG. 6) to PBAs or PPAs.

In some embodiments, the NAND unit can include at least one of NAND physical page (e.g., physical page 111, 112, 113, 114, 116, 117, 118, 119, 121, 122, 123, 124, 126, 127, 128 or 129 of FIG. 1, physical page 212, 213, 214, 216, 217, 218, 220, 221, or 222 of FIG. 2), NAND physical block (e.g., physical block 110, 115, 120, 125 of FIG. 1, physical block 211, 215, or 219 of FIG. 2), NAND plane (e.g., plane 203, 204, 206, 207, 209, or 210 of FIG. 2), NAND IC (e.g., NAND IC 202, NAND IC 205, or NAND IC 208 of FIG. 1, NAND IC 424_1, 424_2, . . . , or 424_p of FIG. 4), NAND channel (e.g., NAND channel 201 of FIG. 2, NAND channel 423_1, 423_2, . . . , or 423_k of FIG. 4, NAND channel 504_1, 504_2, . . . , or 504_k of FIG. 5, NAND channel 604_1, 604_2, . . . , or 604_k of FIG. 6), and NAND block band (e.g., NAND block band 750 or 760 of FIG. 7).

Embodiments of the present disclosure can be applied to many products. For example, some embodiments of the present disclosure can be applied to Ali-NPU (e.g., Hanguang NPU), Ali-Cloud, Ali PIM-AI (Processor-in Memory for AI), Ali-DPU (Database Acceleration Unit), Ali-AI platform, Ali-Data Center AI Inference Chip, IoT Edge AI Chip, GPU, TPU, or the like.

The embodiments may further be described using the following clauses:

1. A method for data storage, comprising:

aligning a plurality of sets of data blocks in a plurality of queues;

buffering the plurality of sets of data blocks from the plurality of queues in one or more data buffers, each set of data blocks in the one or more data buffers having the same order as that in the plurality of queues; and

storing the data blocks in each data buffer into a NAND unit.

2. The method of clause 1, wherein aligning the plurality of sets of data blocks in the plurality of queues comprises:

aligning a first set of data blocks in a first queue; and

aligning a second set of data blocks in a second queue.

3. The method of clause 2, wherein the first set of data blocks are from a first namespace and the second set of data blocks are from a second namespace.
4. The method of clause 2, wherein the first set of data blocks and the second set of data blocks are from a same data chunk.
5. The method of clause 2, wherein the first set of data blocks are from a first data chunk, and a part of the second set of data blocks are from the first data chunk and another part of the second set of data blocks are from a second data chunk.
6. The method of clause 2, wherein the first set of data blocks and the second set of data blocks are from a first namespace.
7. The method of any one of clauses 1-6, wherein buffering the plurality of sets of data blocks from the plurality of queues in one or more data buffers comprises:

sequentially receiving a set of data blocks from a queue; and

sequentially storing the received set of data blocks in a data buffer.

8. The method of any one of clauses 1-7, wherein buffering the plurality of sets of data blocks from the plurality of queues in one or more data buffers comprises:

buffering a first set of data blocks from a first queue in a first data buffer; and

buffering a second set of data blocks from a second queue in a second data buffer.

9. The method of any one of clauses 1-7, wherein buffering the plurality of sets of data blocks from the plurality of queues in one or more data buffers comprises:

buffering a first set of data blocks from a first queue and a second set of data blocks from a second queue in a first data buffer.

10. The method of clause 9, wherein storing the data blocks in each data buffer into the NAND unit comprises:

storing the first set of data blocks into a first NAND unit after buffering the first set of data blocks; and

storing the second set of data blocks into the first NAND unit after buffering the second set of data blocks.

11. The method of clause 9, wherein storing the data blocks in each data buffer into the NAND unit comprises:

storing the first set of data blocks and the second set of data blocks into a first NAND unit after buffering both the first set of data blocks and the second set of data blocks.

12. The method of clause 9, further comprising:

aligning a third set of data blocks in the first queue after buffering the first set of data blocks;

aligning a fourth set of data blocks in the second queue after buffering the second set of data blocks;

buffering the third set of data blocks and the fourth set of data blocks in a second data buffer; and

storing the third set of data blocks into a second NAND unit after buffering the third set of data blocks; and

storing the fourth set of data blocks into the second NAND unit after buffering the fourth set of data blocks.

13. The method of any one of clauses 1-12, further comprising:

translating logic block addresses (LBAs) of the plurality of sets of data blocks to physical block addresses (PBAs) or physical page addresses (PPAs).

14. The method of any one of clauses 1-13, wherein the NAND unit comprises at least one of NAND physical page, NAND physical block, NAND plane, NAND IC, NAND channel, and NAND block band.
15. An apparatus for data storage, comprising:

at least one memory for storing instructions; and

at least one processor configured to execute the instructions to cause the apparatus to perform:
aligning a plurality of sets of data blocks in a plurality of queues;
buffering the plurality of sets of data blocks from the plurality of queues in one or more data buffers, each set of data blocks in the one or more data buffers having the same order as that in the plurality of queues; and
storing the data blocks in each data buffer into a NAND unit.
   16. The apparatus of clause 15, wherein the at least one processor is configured to execute the instructions to cause the apparatus to perform:

aligning a first set of data blocks in a first queue; and

aligning a second set of data blocks in a second queue.

17. The apparatus of clause 16, wherein the first set of data blocks are from a first namespace and the second set of data blocks are from a second namespace.
18. The apparatus of clause 16, wherein the first set of data blocks and the second set of data blocks are from a same data chunk.
19. The apparatus of clause 16, wherein the first set of data blocks are from a first data chunk, and a part of the second set of data blocks are from the first data chunk and another part of the second set of data blocks are from a second data chunk.
20. The apparatus of clause 16, wherein the first set of data blocks and the second set of data blocks are from a first namespace.
21. The apparatus of any one of clauses 15-20, wherein the at least one processor is configured to execute the instructions to cause the apparatus to perform:

sequentially receiving a set of data blocks from a queue; and

sequentially storing the received set of data blocks in a data buffer.

22. The apparatus of any one of clauses 15-21, wherein the at least one processor is configured to execute the instructions to cause the apparatus to perform:

buffering a first set of data blocks from a first queue in a first data buffer; and

buffering a second set of data blocks from a second queue in a second data buffer.

23. The apparatus of any one of clauses 15-21, wherein the at least one processor is configured to execute the instructions to cause the apparatus to perform:

buffering a first set of data blocks from a first queue and a second set of data blocks from a second queue in a first data buffer.

24. The apparatus of clause 23, wherein the at least one processor is configured to execute the instructions to cause the apparatus to perform:

storing the first set of data blocks into a first NAND unit after buffering the first set of data blocks; and

storing the second set of data blocks into the first NAND unit after buffering the second set of data blocks.

25. The apparatus of clause 23, wherein the at least one processor is configured to execute the instructions to cause the apparatus to perform:

storing the first set of data blocks and the second set of data blocks into a first NAND unit after buffering both the first set of data blocks and the second set of data blocks.

26. The apparatus of clause 23, wherein the at least one processor is configured to execute the instructions to cause the apparatus to perform:

aligning a third set of data blocks in the first queue after buffering the first set of data blocks;

aligning a fourth set of data blocks in the second queue after buffering the second set of data blocks;

buffering the third set of data blocks and the fourth set of data blocks in a second data buffer;

storing the third set of data blocks into a second NAND unit after buffering the third set of data blocks; and

storing the fourth set of data blocks into the second NAND unit after buffering the fourth set of data blocks.

27. The apparatus of any one of clauses 15-26, wherein the at least one processor is configured to execute the instructions to cause the apparatus to perform:

translating logic block addresses (LBAs) of the plurality of sets of data blocks to physical block addresses (PBAs) or physical page addresses (PPAs).

28. The apparatus of any one of clauses 15-27, wherein the NAND unit comprises at least one of NAND physical page, NAND physical block, NAND plane, NAND IC, NAND channel, and NAND block band.
29. A non-transitory computer readable storage medium storing a set of instructions that are executable by one or more processing devices to cause a computer to perform a method comprising:

aligning a plurality of sets of data blocks in a plurality of queues;

buffering the plurality of sets of data blocks from the plurality of queues in one or more data buffers, each set of data blocks in the one or more data buffers having the same order as that in the plurality of queues; and

storing the data blocks in each data buffer into a NAND unit.

30. The non-transitory computer readable storage medium of clause 29, wherein the set of instructions are executable by the one or more processing devices to cause the computer to perform:

aligning a first set of data blocks in a first queue; and

aligning a second set of data blocks in a second queue.

31. The non-transitory computer readable storage medium of clause 30, wherein the first set of data blocks are from a first namespace and the second set of data blocks are from a second namespace.
32. The non-transitory computer readable storage medium of clause 30, wherein the first set of data blocks and the second set of data blocks are from a same data chunk.
33. The non-transitory computer readable storage medium of clause 30, wherein the first set of data blocks are from a first data chunk, and a part of the second set of data blocks are from the first data chunk and another part of the second set of data blocks are from a second data chunk.
34. The non-transitory computer readable storage medium of clause 30, wherein the first set of data blocks and the second set of data blocks are from a first namespace.
35. The non-transitory computer readable storage medium of any one of clauses 29-34, wherein the set of instructions are executable by the one or more processing devices to cause the computer to perform:

sequentially receiving a set of data blocks from a queue; and

sequentially storing the received set of data blocks in a data buffer.

36. The non-transitory computer readable storage medium of any one of clauses 29-35, wherein the set of instructions are executable by the one or more processing devices to cause the computer to perform:

buffering a first set of data blocks from a first queue in a first data buffer; and

buffering a second set of data blocks from a second queue in a second data buffer.

37. The non-transitory computer readable storage medium of any one of clauses 29-35, wherein the set of instructions are executable by the one or more processing devices to cause the computer to perform:

buffering a first set of data blocks from a first queue and a second set of data blocks from a second queue in a first data buffer.

38. The non-transitory computer readable storage medium of clause 37, wherein the set of instructions are executable by the one or more processing devices to cause the computer to perform:

storing the first set of data blocks into a first NAND unit after buffering the first set of data blocks; and

storing the second set of data blocks into the first NAND unit after buffering the second set of data blocks.

39. The non-transitory computer readable storage medium of clause 37, wherein the set of instructions are executable by the one or more processing devices to cause the computer to perform:

storing the first set of data blocks and the second set of data blocks into a first NAND unit after buffering both the first set of data blocks and the second set of data blocks.

40. The non-transitory computer readable storage medium of clause 37, wherein the set of instructions are executable by the one or more processing devices to cause the computer to perform:

aligning a third set of data blocks in the first queue after buffering the first set of data blocks;

aligning a fourth set of data blocks in the second queue after buffering the second set of data blocks;

buffering the third set of data blocks and the fourth set of data blocks in a second data buffer;

storing the third set of data blocks into a second NAND unit after buffering the third set of data blocks; and

storing the fourth set of data blocks into the second NAND unit after buffering the fourth set of data blocks.

41. The non-transitory computer readable storage medium of any one of clauses 29-40, wherein the set of instructions are executable by the one or more processing devices to cause the computer to perform:

translating logic block addresses (LBAs) of the plurality of sets of data blocks to physical block addresses (PBAs) or physical page addresses (PPAs).

42. The non-transitory computer readable storage medium of any one of clauses 29-41, wherein the NAND unit comprises at least one of NAND physical page, NAND physical block, NAND plane, NAND IC, NAND channel, and NAND block band.

The various example embodiments described herein are described in the general context of method steps or processes, which may be implemented in one aspect by a computer program product, embodied in a computer readable medium, including computer-executable instructions, such as program code, executed by computers in networked environments. A computer readable medium may include removeable and nonremovable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the present disclosure are apparent from the detailed specification, and thus, it is intended that the appended claims cover all systems and methods falling within the true spirit and scope of the present disclosure. As used herein, the indefinite articles “a” and “an” mean “one or more.” Further, since numerous modifications and variances will readily occur from studying the present disclosure, it is not desired to limit the present disclosure to the exact reconstruction and operation illustrated and described, and accordingly, all suitable modifications and equivalents may be resorted to, falling within the scope of the present disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for data storage, comprising:
aligning a plurality of sets of data blocks in a plurality of queues;
buffering the plurality of sets of data blocks from the plurality of queues in one or more data buffers, each set of data blocks in the one or more data buffers having the same order as that in the plurality of queues; and
storing the data blocks in each data buffer into a NAND unit.

2. The method of claim 1, wherein aligning the plurality of sets of data blocks in the plurality of queues comprises:
aligning a first set of data blocks in a first queue; and
aligning a second set of data blocks in a second queue.

3. The method of claim 2, wherein the first set of data blocks are from a first namespace and the second set of data blocks are from a second namespace.

4. The method of claim 2, wherein the first set of data blocks and the second set of data blocks are from a same data chunk.

5. The method of claim 2, wherein the first set of data blocks are from a first data chunk, and a part of the second set of data blocks are from the first data chunk and another part of the second set of data blocks are from a second data chunk.

6. The method of claim 2, wherein the first set of data blocks and the second set of data blocks are from a first namespace.

7. The method of claim 1, wherein buffering the plurality of sets of data blocks from the plurality of queues in one or more data buffers comprises:
sequentially receiving a set of data blocks from a queue; and
sequentially storing the received set of data blocks in a data buffer.

8. The method of claim 1, wherein buffering the plurality of sets of data blocks from the plurality of queues in one or more data buffers comprises:
buffering a first set of data blocks from a first queue in a first data buffer; and
buffering a second set of data blocks from a second queue in a second data buffer.

9. The method of claim 1, wherein buffering the plurality of sets of data blocks from the plurality of queues in one or more data buffers comprises:
buffering a first set of data blocks from a first queue and a second set of data blocks from a second queue in a first data buffer.

10. The method of claim 9, wherein storing the data blocks in each data buffer into the NAND unit comprises:
storing the first set of data blocks into a first NAND unit after buffering the first set of data blocks; and
storing the second set of data blocks into the first NAND unit after buffering the second set of data blocks.

11. The method of claim 9, further comprising:
aligning a third set of data blocks in the first queue after buffering the first set of data blocks;
aligning a fourth set of data blocks in the second queue after buffering the second set of data blocks;
buffering the third set of data blocks and the fourth set of data blocks in a second data buffer; and
storing the third set of data blocks into a second NAND unit after buffering the third set of data blocks; and
storing the fourth set of data blocks into the second NAND unit after buffering the fourth set of data blocks.

12. The method of claim 1, further comprising:
translating logic block addresses (LBAs) of the plurality of sets of data blocks to physical block addresses (PBAs) or physical page addresses (PPAs).

13. The method of claim 1, wherein the NAND unit comprises at least one of NAND physical page, NAND physical block, NAND plane, NAND IC, NAND channel, and NAND block band.

14. An apparatus for data storage, comprising:
at least one memory for storing instructions; and
at least one processor configured to execute the instructions to cause the apparatus to perform:
aligning a plurality of sets of data blocks in a plurality of queues;
buffering the plurality of sets of data blocks from the plurality of queues in one or more data buffers, each set of data blocks in the one or more data buffers having the same order as that in the plurality of queues; and
storing the data blocks in each data buffer into a NAND unit.

15. A non-transitory computer readable storage medium storing a set of instructions that are executable by one or more processing devices to cause a computer to perform a method comprising:
aligning a plurality of sets of data blocks in a plurality of queues;
buffering the plurality of sets of data blocks from the plurality of queues in one or more data buffers, each set of data blocks in the one or more data buffers having the same order as that in the plurality of queues; and
storing the data blocks in each data buffer into a NAND unit.

16. The non-transitory computer readable storage medium of claim 15, wherein the set of instructions are executable by the one or more processing devices to cause the computer to perform:
aligning a first set of data blocks in a first queue; and
aligning a second set of data blocks in a second queue.

17. The non-transitory computer readable storage medium of claim 16, wherein the first set of data blocks are from a first namespace and the second set of data blocks are from a second namespace.

18. The non-transitory computer readable storage medium of claim 16, wherein the first set of data blocks and the second set of data blocks are from a same data chunk.

19. The non-transitory computer readable storage medium of claim 16, wherein the first set of data blocks are from a first data chunk, and a part of the second set of data blocks are from the first data chunk and another part of the second set of data blocks are from a second data chunk.

20. The non-transitory computer readable storage medium of claim 16, wherein the first set of data blocks and the second set of data blocks are from a first namespace.
